(19) United States
(12) Patent Application Publication
(10) Pub. No.: US 2025/0382232 A1
(43) Pub. Date: Dec. 18, 2025

(54) METHOD FOR PREPARING A POWDER COMPRISING ONE OR MORE OXIDES SELECTED FROM URANIUM OXIDE UO2, PLUTONIUM OXIDE PuO2 AND MINOR ACTINIDE OXIDES

(71) Applicant: COMMISSARIAT A L'ÉNERGIE ATOMIQUE ET AUX ENERGIES ALTERNATIVES, Paris (FR)

(72) Inventors: Laure RAMOND, Theziers (FR); Guillaume BERNARD-GRANGER, Mazan (FR); Franck DOREAU, Tresques (FR); Cécile PAGNOUX, Couzeix (FR); Florian LA LUMIA, Aix-en-Provence (FR); Patrice SIGNORET, Carpentras (FR)

(73) Assignee: COMMISSARIAT A L'ÉNERGIE ATOMIQUE ET AUX ENERGIES ALTERNATIVES, Paris (FR)

(21) Appl. No.: 19/238,725

(22) Filed: Jun. 16, 2025

(30) Foreign Application Priority Data
Jun. 17, 2024 (FR) FR2406367

(51) Int. Cl. C04B 35/51; C04B 35/626; G21C 3/62

(52) U.S. Cl. CPC C04B 35/51; C04B 35/62625; C04B 35/6265; C04B 35/62655; G21C 3/623

(57) ABSTRACT

A method for preparing a powder including one or more oxides selected from uranium oxide UO₂, plutonium oxide PuO₂ and minor actinide oxides, the minor actinides being selected from americium, neptunium and curium, including steps of: a) cryogenic granulation of an aqueous solution comprising cations selected from uranium-based cations, plutonium-based cations, and minor actinide-based cations; b) freeze-drying the granules obtained in a); and c) calcining the granules obtained from b). The method can be used to manufacture nuclear fuels or blankets charged with minor actinide(s).

### TECHNICAL FIELD

The invention relates to a method for preparing a powder comprising one or more oxides selected from uranium oxide UO₂, plutonium oxide PuO₂ and minor actinide oxides.

For the remainder of the disclosure, it is specified that minor actinide means actinide elements other than uranium, plutonium and thorium, which are formed in reactors by successive neutron captures by standard fuel kernels, the minor actinides being americium, curium and neptunium.

More specifically, the invention relates to a method for preparing a powder which is castable, which can be pressed without prior mixing and which can have, more specifically, the following specific physicochemical characteristics:
good spontaneous flowability;
homogeneous particle size distribution centred in the range from 5 μm to 500 μm;
good homogeneity of the elements within the powder particles, when the powder comprises several different actinide elements;
limited structural carbon content within the powder particles;
minimum fine particle content in the powder, in order to avoid particle dispersal within equipment and glove boxes;
good compactability; and
excellent reactivity to natural sintering.

On account of the physicochemical characteristics mentioned above, the powder obtained by the method of the invention may be suitable for the preparation of the following materials:
uranium oxide UO₂ fuels;
mixed uranium and plutonium oxide (U,Pu) O₂ fuels, referred to as MOX fuels, currently used in light-water reactors, or high-plutonium-content MOX fuels which can be used in fast neutron reactors;
blankets charged with minor actinide(s), such as transmutation targets based on minor actinide(s) intended to perform nuclear transmutation experiments in fast neutron reactors, in particular with a view to gaining a better understanding of the transmutation mechanism of these minor actinide elements, where these targets can consist of a MOX type material containing from 1% to 5% by mass of minor actinide(s) (where this material can be symbolised by the formula (U,Pu,Am,Np,Cm)O₂) or of a material comprising an uranium oxide matrix comprising from 10% to 20% by mass of minor actinide(s) (where this material can be symbolised by the formula (U,Am,Np,Cm)O₂).

### PRIOR ART

The manufacture of mixed uranium and plutonium oxide (U,Pu)O₂ fuels, referred to as MOX fuels, has been the subject of various developments linked with the drive to recycle plutonium recovered during used nuclear fuel processing. Recycling plutonium by manufacturing and irradiating MOX fuels is now considered as a means for limiting the proliferation of plutonium.

Several methods for manufacturing MOX fuels have been developed over the last two decades, some making use of complete grinding of UO₂ and PuO₂ powders to ensure intimate mixing, others being limited to grinding only a fraction of these powders.

Currently, the preparation of the mixed oxide (U,Pu)O₂ is carried out by dry mechanical mixing of UO₂ and PuO₂ oxide powders. The mixture obtained makes it possible, after pressing, sintering and rectification, to produce MOX fuel pellets meeting current specifications. The most tried-and-tested industrial method includes two main steps in powder preparation: cogrinding the uranium oxide and plutonium oxide powders to produce a first mixture, referred to as master mixture, which is characterised by a plutonium content of 25% to 30%, then dry dilution of this master mixture with uranium oxide, until the desired final plutonium content is obtained.

The PuO₂ powder used in the manufacture of MOX fuels is sourced from the processing of used uranium fuels, from light-water reactors. This processing is carried out via the PUREX method by liquid-liquid extraction. Following this method, concentrated solutions of depleted uranyl nitrate, on one hand, and plutonium nitrate, on the other, are obtained. The concentrated plutonium nitrate solution is then converted into a plutonium oxide PuO₂ powder by oxalic precipitation of plutonium, filtration of the plutonium oxalate solution thus obtained, followed by spinning, drying and calcination of the plutonium oxalate precipitate.

Other liquid-liquid extraction methods have also been developed for selective recovery of minor actinides (such as selective extraction of americium by the EXAm method or grouped extraction of the minor actinides americium, curium and neptunium by the GANEX or SANEX methods).

For the manufacture of MOX fuels, the UO₂ and PuO₂ oxide powders used must meet precise characteristics. In particular, they must have good flowability, good compressibility characteristics and be suitable for densification by sintering. Plutonium distribution homogeneity is an important quality criterion in the final properties of the sintered material. Good homogeneity, in each sintered pellet, is, on one hand, very favourable for the behaviour of the MOX fuel in a reactor, particularly with a view to increasing combustion rates, and, on the other, facilitates the complete dissolution of used fuels during the processing operations of these fuels.

As for transmutation targets, they have been the subject of extensive studies in order to allow, besides their purposes mentioned above, recycling of minor actinides from the processing of used fuels from pressurised water reactors.

This type of recycling takes place via two separate channels referred to as: heterogeneous recycling and homogeneous recycling.

In the case of heterogeneous recycling, minor actinides are separated, during used fuel processing, from uranium and plutonium, and are subsequently incorporated, at a high content (about 10% to 20% atomic), into fuel elements comprising a distinct non-fissile matrix (e.g., depleted UO₂) from standard reactor fuel elements. Fuel elements comprising minor actinides can consist, for example, of blanket elements disposed at the periphery of a reactor core. This recycling channel makes it possible, in particular, to avoid degrading standard fuel characteristics by minor actinide incorporation by concentrating the problems generated by these actinides on a reduced material flow.

In the case of homogeneous recycling, minor actinides are mixed, at a low content (less than 5% atomic), distributed quasi-uniformly in all of the standard fuel elements of the reactor. To do this, during used fuel processing, uranium, plutonium and minor actinides are processed together to form oxides, which are subsequently used in the manufacture of said fuels.

Whether for the manufacture of nuclear fuels or transmutation targets, the methods recently proposed tend to aim for techniques limiting the dispersal of fine particles (and, hence, dust accumulation of glove boxes wherein these fuels or targets are manufactured) and improving the homogeneity of the elements in the pellets.

This is the case of the WAR (Weak Acid Resin, so named because it is based on the use of a weakly acidic ion exchange resin) method, which aims to obtain homogeneous spherules of mixed oxides (U,Am)O₂ without involving a granulation phase, which substantially limits the dispersal of fine particles, unlike conventional powder metallurgy methods, which implement granulation steps, such as grinding, screening and mixing. Another method involving a phase of spray-drying an aqueous suspension comprising a UO₂ powder obtained by dry process from UF₆ was described in international application WO-A-00/30978, hereinafter reference [1]. Although this method does not involve grinding, screening and mixing steps, it still generates a non-negligible fine particle content during spray-drying.

Finally, international application WO-A-2019/038497, hereinafter reference [2], proposes a method also making it possible to avoid the formation and dispersal of fine particles during the manufacture of nuclear fuels or transmutation targets and which consists of subjecting an aqueous suspension comprising a UO₂ powder and, optionally, a PuO₂ powder and/or a minor actinide oxide powder, to cryogenic granulation, then freeze-drying the granules thus obtained, after which they can be compacted directly into pellets. While this method undeniably has many advantages, including that of resulting in obtaining oxide particles with remarkable physicochemical characteristics while limiting the risk of fine particle dispersal, it does not entirely remove this risk because cryogenic granulation is carried out on an aqueous suspension comprising one or more oxide powders, the preparation of which may itself have been a source of dispersal.

The inventors therefore set themselves the objective of providing a novel method for preparing a powder comprising one or more actinide oxides, which, while resulting in obtaining oxide particle(s) with physicochemical properties as advantageous as those of the particles obtained by the method of reference [2], reduces the risk of fine particle dispersal even further.

They additionally set themselves the objective of this method furthermore making it possible to:
avoid the inherent constraints to the preparation of actinide oxide powders and, in particular, that of PuO₂, oxalic precipitation and filtration operations being capable of generating problems of filter clogging and, thereby, of supply of the furnace used for calcining the plutonium oxalate precipitate;
minimise, for powders obtained following the method, raw shaping problems, for example, by dry pressing thanks to the optimization and robustness of the rheological properties of the powders obtained; and
minimise, when manufacturing the pellets from the powders obtained following the method, the scrap rate by minimising the inherent problems to raw shaping and by having, when the powders contain elements other than uranium, a homogeneous distribution of the different elements.

### DISCLOSURE OF THE INVENTION

The invention relates to a method for preparing a powder comprising one or more oxides selected from uranium oxide UO₂, plutonium oxide PuO₂ and minor actinide oxides, the minor actinides being selected from americium, neptunium and curium, comprising steps of:
a) cryogenic granulation of an aqueous solution comprising cations selected from uranium-based cations, plutonium-based cations, and minor actinide-based cations;
b) freeze-drying the granules obtained in a); and
c) calcining the granules obtained from b);
   whereby the powder is obtained.

Thus, according to the invention, an aqueous solution containing “precursor” cations of the oxide or oxide mixture intended to be present in the powder is subjected to cryogenic granulation and not an aqueous suspension comprising an oxide powder or an oxide powder mixture as in reference [2].

Besides meeting the objectives already mentioned above, the method of the invention also has the following advantages:
the use of water as a solvent is particularly advantageous, because it makes it possible to limit the use of organic products and thus limit impurities in the powder finally obtained;
simple, quick, reproducible implementation, resulting in, during step a), a solution which can be conveyed simply by pumping to the injection nozzle of a cryogenic granulation apparatus without any difficulty;
combined use of a solution, cryogenic granulation and freeze-drying making it possible to obtain a powder comprising solid, spherical, controlled-porosity particles with good distribution homogeneity of the elements and good castability;
option of obtaining powders while avoiding the oxalic precipitation and filtration steps usually implemented to recover uranium and, where applicable, plutonium from nitric solutions; and
option of implementing this method in an industrial capacity production unit accounting for the criticality and therefore the geometry of the apparatuses. As previously stated, step a) consists of a step of cryogenic granulation of the aqueous solution mentioned above, where this step can consist of spraying or atomizing—the two words being considered here as synonymous—this solution in droplet form, for example, by passing this solution through a nozzle, and placing the droplets thus formed in contact with a liquid at a very low temperature (e.g., liquid nitrogen) to solidify the droplets in their shape.

Such a step a) can be performed in a commercial granulation device or in a device specially prepared in a laboratory for the implementation of this step. This device can consist of a peristaltic pump which makes it possible to convey the aqueous solution to a nozzle to allow the granulation of the solution. The microdroplets formed and sprayed by the nozzle fall into a Dewar filled with liquid nitrogen under stirring (by means, for example, of a magnetic bar) and are solidified directly in spherical form.

In the aqueous solution subjected to step a), the cations, whether they are based on uranium, plutonium, americium, neptunium, and/or curium, can be associated with anions to form salt compounds and/or can be associated with organic ligands to form complexes, and, more specifically, coordination complexes.

The aqueous solution subjected to step a) is advantageously an aqueous nitric solution (or, in other words, an aqueous solution of nitric acid, for example with a concentration ranging from 0.5 mol/L to 15 mol/L, preferably between 1 mol/L and 8 mol/L). In such a context, if uranium-based cations are present, these cations are uranyl UO₂²⁺ cations coexisting with nitrate ions to form uranyl nitrate UO₂(NO₃)₂; if plutonium-based cations are present, then these cations are Pu⁴⁺ cations associated with nitrate ions to form plutonium nitrate Pu(NO₃)₄, while if cations based on one or more minor actinides are present, then these cations are cations M^{x+} associated with nitrate ions to form one or more nitrates M(NO₃)ₓ (where M denotes Am, Np or Cm and x ranges from 3 to 6, the value of x being fixed so as to ensure the electroneutrality of M(NO₃)ₓ).

This aqueous nitric solution can be obtained, in particular, from liquid-liquid extraction methods such as the PUREX or GANEX/EXAm method, where the concentration of this solution can be adjusted in advance by evaporation before the implementation of the method of the invention.

It goes without saying that the method is not limited to the cryogenic granulation of an aqueous nitric solution comprising cations associated with nitrate ions and that other aqueous acidic solutions such as, for example, an aqueous sulphuric acid solution wherein the cations are associated with sulphate ions may be suitable.

The aqueous solution subjected to step a) comprises, in particular, a total concentration of actinide element(s) (uranium and/or plutonium and/or minor actinide(s)) ranging from 5 g/L to 300 g/L.

When the aqueous solution subjected to step a) is an aqueous solution of uranium-based cations, it can comprise an infinitesimal quantity of plutonium-based cations according to the method whereby this solution was obtained. Conversely, when the aqueous solution subjected to step a) is an aqueous solution of plutonium-based cations, it can comprise an infinitesimal quantity of uranium-based cations according to the method whereby this solution was obtained.

According to the invention, the aqueous solution subjected to step a) can also comprise uranium-based cations and plutonium-based cations (but without minor actinide-based cations) with a molar (or atomic) proportion of plutonium (as determined by the ratio Pu/(U+Pu)) which can range from 1% to 99% according to the intended use of the powder to be prepared (use for scientific research purposes, use for the purposes of experimental or industrial manufacture of new nuclear fuels, etc.).

By way of example, for the manufacture of MOX fuels intended for light-water reactors or LWRs (pressurised water reactors and boiling water reactors), then the aqueous solution subjected to step a) has, preferably, a molar (or atomic) proportion of plutonium ranging from 3% to 12% whereas, for the manufacture of MOX fuels intended for fast neutron nuclear reactors or FNRs, then said aqueous solution has, preferably, a molar (or atomic) proportion of plutonium ranging from 15% to 40%.

When the solution comprises uranium-based cations and cations based on one or more minor actinides (but without plutonium-based cations), then the molar (or atomic) proportion of minor actinide(s) ranges, preferably, from 1% to 50% (determined by the ratio M/(U+M)), where M is the minor actinide(s)).

Furthermore, the aqueous solution subjected to step a) can comprise at least one additive selected from water-soluble organic polymers, nitrogenous organic compounds and mixtures thereof, this or these additives being advantageously present in a quantity such that the dynamic viscosity (for a shear rate of 1500 s⁻¹) of the aqueous solution does not exceed 1000 mPa.s and, preferably, does not exceed 100 mPa.s.

The advantage of using such additives lies in their ability to increase the viscosity of the solution, in order to control the shape of the granules obtained subsequently during the cryogenic granulation step.

As examples of water-soluble organic polymers, mention may be made of polyvinyl alcohol (PVA), a polyethylene glycol (PEG), a poly (vinyl butyral) (known as the abbreviation PVB), an acrylic latex, or a mixture thereof.

As examples of nitrogenous organic compounds, mention may be made of amide compounds or amine compounds.

The dynamic viscosity is conventionally measured using a rheometer for a shear rate of 1500 s⁻¹ with a cylinder-cone configuration system at ambient temperature and pressure (i.e. without applying external heating and pressurisation other than the temperature and pressure of the ambient atmosphere, where the ambient temperature can be a temperature of 20° C. and the ambient pressure can be atmospheric pressure). Preferably, the dynamic viscosity does not exceed 100 mPa.s, which corresponds to a very fluid solution, which will be able to flow readily through the supply pipes and the atomizing nozzle of the cryogenic granulation device.

Furthermore, the solution can comprise one or more complex stabilising agents, when the uranium-based cations, plutonium-based cations and/or cations based on one or more minor actinides are associated with organic ligands, to form complexes.

Prior to step a), the method of the invention can comprise a step of preparing the solution comprising uranium-based cations, plutonium-based cations and/or cations based on one or more minor actinides by contacting the different ingredients of this solution and in the desired proportions.

For example, the aqueous solution can be prepared by contacting then mixing different nitric solutions comprising the different desired elements optionally followed by a concentration by evaporation of water in order to reach the desired concentrations.

According to the method of the invention, after the cryogenic granulation step, the granules obtained are subjected to a freeze-drying step, for example, by placing them in a freeze-dryer to allow sublimation of the frozen water and to preserve the shape of the granules (and in particular their spherical shape) and their particular features.

At the end of freeze-drying, the residual moisture in the granules is very low, which prevents the granules from drying out before their calcination.

When the aqueous solution subjected to step a) is an aqueous nitric acid solution, the granules obtained from the freeze-drying step are granules comprising uranyl nitrate UO₂(NO₃) and/or plutonium nitrate Pu(NO₃)₄ and/or one or more nitrates M(NO₃)ₓ (where M denotes Am, Np or Cm and x ranges from 3 to 6, the value of x being fixed so as to ensure the electroneutrality of M(NO₃)ₓ).

After the freeze-drying step, the method of the invention comprises a step of calcining the granules.

This calcination can be oxidative or reducing, or oxidative followed by reducing depending on the actinide elements retained and the desired valency adjustment.

If the granules are free from uranium-based cations, i.e. they only comprise plutonium-based cations or cations based on one or more minor actinides or a mixture of plutonium-based cations and cations based on one or more minor actinides, then calcination can be carried out in a single step, i.e. either in an oxidising atmosphere or in a reducing atmosphere, preference being however given to an oxidising atmosphere.

If the granules comprise uranium-based cations (alone or with other cations), then calcination can be carried out in a single step in a reducing atmosphere but it is preferably carried out in two successive steps, a first step in an oxidising atmosphere allowing the removal of any organic matter and the formation of U₃O₈, followed by a second step in a reducing atmosphere allowing the conversion of U₃O₈ into UO₂.

Calcination in an oxidising atmosphere can consist of a heating operation, for example in air or in an oxygen-enriched atmosphere such as an atmosphere comprising 80% by volume of oxygen at a temperature ranging from 100° C. to 1200° C., preferably less than 800° C. for a duration of up to 12 hours, preferably less than 4 hours. This calcination is isomorphic, in that its implementation does not affect the shape of the granules subjected to this step.

Calcination in a reducing atmosphere can consist of a heating operation, for example in hydrogenated argon, at a temperature ranging from 300° C. to 1200° C., preferably less than 900° C., for a duration of up to 12 hours, preferably less than 4 hours.

Following the method of the invention, a powder that can specifically have the following features is obtained:
homogeneous particle size distribution centred in the range from 5 μm to 500 μm;
sufficient granule cohesion to withstand handling for pellet preparation;
excellent flow properties, in particular good spontaneous flowability;
good compactability;
excellent natural sinterability;
good distribution homogeneity of the elements within the powder, when the powder includes several actinide elements (uranium and/or plutonium and/or minor actinide(s)); and
minimum fine particles within the powder, thus limiting dispersal and contamination risks.

The almost perfect spherical shape of these granules allows very good castability in pressing moulds to obtain pellets which will subsequently be sintered.

As for the distribution homogeneity of the elements, it is particularly substantial in relation to the plutonium element if it is present. Once the powder has been compacted and sintered to form a MOX fuel, the distribution homogeneity of plutonium is very favourable for the behaviour of the fuel in the reactor, particularly with a view to increasing combustion rates, and also facilitates the complete dissolution of used fuel during future processing operations.

According to the invention, the powder is preferably a UO₂ powder, a PuO₂ powder, a powder comprising a mixture of UO₂ and PuO₂ such as a powder having a molar ratio Pu/(U+Pu) of 12% (LWR type) or of 30% (FNR type), any preference being given to a powder comprising a mixture of UO₂ and PuO₂.

The powder obtained according to the method of the invention can be used directly (i.e. without requiring the addition of other ingredients) to form a compacted material, for example, in the form of nuclear fuel pellets.

Thus, the invention also relates to a method for preparing nuclear fuel pellets successively comprising steps of:
i) implementing the method for preparing a powder as defined above;
ii) compacting the powder obtained in i) in pellet form; and
iii) sintering the pellets obtained in ii).

The compaction step ii) can consist, on one hand, of placing the powder in a mould of a shape adapted to form one or more pellets and, on the other, subjecting this powder to uniaxial pressing, for example, using a piston applying a pressure to the powder placed in the mould, where this pressure can range from 150 MPa to 1000 MPa for a duration capable of ranging from 1 second to 10 minutes.

The sintering step iii) can consist of heating the pellets mentioned above, for example, to a temperature ranging from 1000° C. to 1800° C., for a step duration capable of ranging from 1 hour to 8 hours, preferably from 3 hours to 5 hours, in a neutral gas atmosphere, such as argon, optionally comprising dry or humidified hydrogen, where hydrogen can be present in the mixture at a content of up to 5% by volume and water can be present in the mixture at a content of up to 20,000 ppm.

Thus, for example, the sintering of UO₂ pellets can be carried out both in an atmosphere consisting only of argon and in a mixture of argon and dry or humidified hydrogen whereas, for the sintering of pellets comprising a mixture of UO₂ and PuO₂, a mixture of argon and dry or humidified hydrogen is typically used.

Alternatively, between step i) and step ii), to the powder obtained from step i), a powder of an uranium oxide, such as a powder of U₃O₈, a PuO₂ powder and/or at least one powder of a minor actinide oxide can be added in order to adjust the targeted composition, if necessary.

In any case, the nuclear fuel is, preferably, a MOX fuel.

Other features and advantages of the invention will become apparent from the following additional description, which relates to an example of preparation of a mixed powder and fuel pellets according to embodiments according to the methods of the invention.

Of course, this additional description is given by way of illustration of the invention and in no way constitutes a limitation.

### DETAILED DISCLOSURE OF SPECIFIC EMBODIMENTS

### Example 1

Preparation of a Mixed UO₂/PuO₂ Powder

This example illustrates the implementation of the method of the invention for the preparation of a mixed powder comprising uranium oxide UO₂ and plutonium oxide PuO₂ in a ratio Pu/(U+Pu) of 10% by weight, this preparation being entirely carried out in a glove box.

An aqueous solution of nitric acid at 5 mol/L, comprising uranyl nitrate and plutonium nitrate in a ratio Pu/(U+Pu) of about 10% by mass ([U]=200 g/L; [Pu]=21 g/L), polyethylene glycol 3400 at 2% by mass and having a dynamic viscosity of less than 20 mPa.s, is placed in a beaker to be taken up by a peristaltic pump (flow rate of 33 mL/min, air pressure of 15 kPa) and sprayed through a nozzle which makes it possible to generate droplets of this solution.

The dynamic viscosity mentioned above is measured using an ANTON PAAR RHEOLAB QC rheometer, at a shear rate of 1500 s⁻¹.

The droplets thus generated fall into a Dewar vessel filled with liquid nitrogen, under magnetic stirring at 300 rpm, whereby they are instantaneously frozen and form granules which retain the original shape of the droplets.

After cryogenic granulation, the granules are quickly placed in a freeze-dryer, with the aim of subliming the frozen water and retaining their spherical shape, this operation taking several hours. When all the water is removed from the granules, they are calcined in an oxidising atmosphere (at 80% by volume of O₂), at 600° C. for 1 hour, to convert the nitrates into oxides, while retaining their morphology, then in a reducing atmosphere (e.g. in hydrogenated argon) to reduce the phase U₃O₈ to UO₂ and results in a powder comprising both UO₂ and PuO₂.

The powder is ready to be pressed into pellets before the sintering step.

The cryogenic granulation mentioned above is implemented in a device comprising the following elements:
a beaker which receives the aqueous solution, this beaker being connected to a peristaltic pump which makes it possible to convey this solution to a spray nozzle, the flow rate of the pump being at most 2 L/h with an air pressure of 15 kPa; and
a Dewar vessel filled with liquid nitrogen, equipped with magnetic stirring (300 rpm), which is connected to the spray nozzle and allows instantaneous freezing of the droplets of solution formed by this nozzle.

### Example 2

Preparation of UO₂/PuO₂ pellets

This example illustrates the preparation of nuclear fuel pellets from the powder obtained in Example 1 above.

To do this, the powder is subjected to cold uniaxial pressing at 500 MPa with external stearic acid lubrication, whereby pellets of 4.5 mm in diameter and 4 mm in height are obtained. These pellets are then subjected to a sintering operation for 4 hours at 1700° C., in an argon atmosphere at 4% by volume of hydrogen and 1200 vpm of water, the temperature of 1700° C. being reached by a temperature rise of 2° C./min in an argon atmosphere at 4% by volume of dry hydrogen.

The pellets thus sintered have relative densities of about 94-96% with a good homogeneity of the elements U and Pu in the pellets (thanks to good homogeneity of these elements within the powder).

### Example 3

Preparation of UO₂/PuO₂ Pellets

In this example, pellets of 4.5 mm in diameter and 4 mm in height are prepared from a powder comprising uranium oxide UO₂ and plutonium oxide PuO₂ in a ratio Pu/(U+Pu) of 10% atomic, this powder having been obtained by a similar method to that described in Example 1 above except that polyethylene glycol was not added to the aqueous solution subjected to cryogenic granulation.

To obtain the pellets, the powder is subjected to cold uniaxial pressing at 600 MPa, with external stearic acid lubrication (no internal lubrication of the granules), then the pellets are sintered for 4 hours at 1700° C., in an argon atmosphere at 4% by volume of hydrogen and 1200 vpm of water, the temperature of 1700° C. being reached by a temperature rise of 2° C./min in an argon atmosphere at 4% by volume of dry hydrogen.

The pellets obtained have relative densities between 97% and 98% with good homogeneity of the elements U and Pu in the pellets (due to the good homogeneity of these elements within the granules).

### Example 4

### Preparation of a UO₂ Powder and Pellets

In this example, a UO₂ powder is prepared by placing an aqueous solution of nitric acid at 1 mol/L, comprising uranyl nitrate, in a beaker to be taken up by a peristaltic pump (flow rate of 40 mL/min, air pressure of 30 kPa) and sprayed through a nozzle which makes it possible to generate droplets of this solution.

The droplets thus generated fall into a Dewar vessel filled with liquid nitrogen, under magnetic stirring at 300 rpm, whereby granules are obtained.

These granules are quickly placed in a freeze-dryer for several hours. When all the water has been removed from the granules, the granules (10-300 μm) are calcined in an oxidising atmosphere (at 80% by volume of oxygen), at 600° C. for 1 hour. A reduction step in an argon atmosphere at 4.3% oxygen is then carried out at 750° C. for 1 hour to reduce U₃Og to UO₂.

The UO₂ powder thus obtained is then pressed in the form of pellets 4.5 mm in diameter and 4 mm in height by uniaxial cold pressing at 500 MPa, with external stearic acid lubrication (no internal lubrication of the granules), then the pellets are sintered for 4 hours at 1700° C., in an argon atmosphere at 4% by volume of hydrogen and 1200 vpm of water, the temperature of 1700° C. being reached by a temperature rise of 2° C./min in an argon atmosphere at 4% dry hydrogen.

The pellets obtained have relative densities of about 93%.

### Example 5

### Preparation of a PuO₂ Powder

This example illustrates the implementation of the method of the invention for the preparation of a powder comprising plutonium oxide PuO₂, this preparation being entirely carried out in a glove box.

An aqueous solution of nitric acid at 1.5 mol/L, comprising plutonium nitrate ([Pu]=35 g/L) is placed in a beaker to be taken up by a peristaltic pump (flow rate of 33 mL/min, air pressure of 15 kPa) and sprayed through a nozzle which makes it possible to generate droplets of this solution.

The droplets thus generated fall into a Dewar vessel filled with liquid nitrogen, under magnetic stirring at 300 rpm, whereby they are instantaneously frozen and form granules which retain the original shape of the droplets.

After cryogenic granulation, the granules are quickly placed in a freeze-dryer, with the aim of subliming the frozen water and retaining their spherical shape, this operation taking several hours. When all the water has been removed from the granules, they are calcined in an oxidising atmosphere (at 80% by volume of O₂), at 600° C. for 30 minutes to convert plutonium nitrate into PuO₂.

The PuO₂ powder thus obtained is ready to be mixed with a UO₂ powder with a view to obtaining UO₂/PuO₂ pellets.

CITATIONS
[1] WO-A-00/30978
[2] WO-A-2019/038497

1. A method for preparing a powder comprising one or more oxides selected from uranium oxide UO₂, plutonium oxide PuO₂ and minor actinide oxides, the minor actinides being selected from americium, neptunium and curium, comprising steps of:
a) cryogenic granulation of an aqueous solution comprising cations selected from uranium-based cations, plutonium-based cations, and minor actinide-based cations;
b) freeze-drying the granules obtained in a); and
c) calcining the granules obtained from b);
whereby the powder is obtained.

2. The method according to claim 1, wherein the cations present in the aqueous solution subjected to step a) are associated with anions to form salt compounds and/or are associated with organic ligands to form complexes.

3. The method according to claim 1, wherein the aqueous solution subjected to step a) is an aqueous nitric acid solution wherein the cations are associated with nitrate ions.

4. The method according to claim 3, wherein the aqueous solution subjected to step a) comprises at least one nitrate selected from uranyl nitrate UO₂(NO₃)₂, plutonium nitrate Pu(NO₃)₄ and nitrates M(NO₃)ₓ, where M is one of the minor actinides and x is an integer ranging from 3 to 6.

5. The method according to claim 1, wherein the aqueous solution subjected to step a) further comprises one or more additives selected from water-soluble organic polymers, nitrogenous organic compounds, and mixtures thereof.

6. The method according to claim 5, wherein the additive(s) are present in a quantity such that the dynamic viscosity of the aqueous solution does not exceed 1000 mPa.s for a shear rate of 1500 s⁻¹.

7. The method according to claim 6, wherein the dynamic viscosity of the aqueous solution does not exceed 100 mPa.s.

8. The method according to claim 5, wherein the water-soluble organic polymer(s) are selected from a polyvinyl alcohol, a polyethylene glycol, a poly (vinyl butyral) and an acrylic latex.

9. The method according to claim 5, wherein the nitrogenous organic compound(s) are selected from amide compounds and amine compounds.

10. The method according to claim 1, wherein the aqueous solution subjected to step a) comprises a total concentration of actinide element(s) ranging from 5 g/L to 300 g/L.

11. The method according to claim 1, wherein the calcination of the granules is an oxidative or reducing calcination or is a calcination which is successively oxidative and then reducing.

12. The method according to claim 1, wherein the powder is a UO₂ powder, a PuO₂ powder or a powder comprising a mixture of UO₂ and PuO₂.

13. A method for preparing nuclear fuel pellets, successively comprising steps of:
i) implementing a method according to claim 1 for preparing a powder;
ii) compacting the powder obtained in i) in pellet form; and
iii) sintering the pellets obtained in ii).

14. The method for preparing nuclear fuel pellets according to claim 13, wherein the nuclear fuel is a MOX fuel.
